(19) United States
(12) Patent Application Publication
(10) Pub. No.: US 2012/0111591 A1
(43) Pub. Date: May 10, 2012

(54) Packaging For Reclaimable Component Of A Medical Device

(76) Inventors: Frederick E. Shelton, IV, Hillsboro, OH (US); Michael J. Stokes, Cincinnati, OH (US); Donna L. Korvick, Maineville, OH (US); Aron O. Zingman, Cambridge, MA (US); John W. Willis, Cincinnati, OH (US); Kevin D. Felder, Cincinnati, OH (US); Christopher B. Anderson, Oak Grove, MN (US); Sora Rhee, Cincinnati, OH (US); Timothy G. Dietz, Terrace Park, OH (US)

(21) Appl. No.: 13/151,488

(22) Filed: Jun. 2, 2011

Related U.S. Application Data
(60) Provisional application No. 61/410,603, filed on Nov. 5, 2010.
(60) Provisional application No. 61/487,846, filed on May 19, 2011.

(51) Int. Cl. B65D 85/86; B23Q 5/00

(52) U.S. Cl. 173/46; 206/723

(57) ABSTRACT

An apparatus for reclaiming insertable electrical components includes a lid, a container base, and a seal. The container base includes a container bottom and sidewalls. The container bottom further includes a recess that is defined by a recess bottom and recess sidewalls and is sized and configured to receive an insertable electrical component. The lid includes at least one boss to restrain the movement of a portion of the insertable electrical component when the insertable electrical component is inserted into the recess of the container base and the lid is attached to the container base. The boss may include a boss contact attached to the boss, and the boss contact may be electrically coupled to a discharge device or to an exterior contact.

### PRIORITY

This application claims priority to U.S. Provisional Application Ser. No. 61/410,603, filed Nov. 5, 2010, entitled “Energy-Based Surgical Instruments,” the disclosure of which is incorporated by reference herein.

This application also claims priority to U.S. Provisional Application Ser. No. 61/487,846, filed May 19, 2011, entitled “Energy-Based Surgical Instruments,” the disclosure of which is incorporated by reference herein.

### BACKGROUND

With the advancement of the electronics industry, medical devices may be adapted to contain most, if not all, of the required components within the medical device. More specifically, some medical devices may be adapted to use an internal or attachable power source instead of requiring the device to be plugged into an external source by a cable. Merely exemplary devices that may be adapted to include a portable power source are disclosed in U.S. Pat. No. 6,500,176 entitled “Electrosurgical Systems and Techniques for Sealing Tissue,” issued Dec. 31, 2002, the disclosure of which is incorporated by reference herein; U.S. Pat. No. 7,416,101 entitled “Motor-Driven Surgical Cutting and Fastening Instrument with Loading Force Feedback,” issued Aug. 26, 2008, the disclosure of which is incorporated by reference herein; U.S. Pat. No. 7,738,971 entitled “Post-Sterilization Programming of Surgical Instruments,” issued Jun. 15, 2010, the disclosure of which is incorporated by reference herein; U.S. Pub. No. 2006/0079874 entitled “Tissue Pad for Use with an Ultrasonic Surgical Instrument,” published Apr. 13, 2006, the disclosure of which is incorporated by reference herein; U.S. Pub. No. 2007/0191713 entitled “Ultrasonic Device for Cutting and Coagulating,” published Aug. 16, 2007, the disclosure of which is incorporated by reference herein; U.S. Pub. No. 2007/0282333 entitled “Ultrasonic Waveguide and Blade,” published Dec. 6, 2007, the disclosure of which is incorporated by reference herein; U.S. Pub. No. 2008/0200940 entitled “Ultrasonic Device for Cutting and Coagulating,” published Aug. 21, 2008, the disclosure of which is incorporated by reference herein; U.S. Pub. No. 2009/0209990 entitled “Motorized Surgical Cutting and Fastening Instrument Having Handle Based Power Source,” published Aug. 20, 2009, the disclosure of which is incorporated by reference herein; and U.S. Pub. No. 2010/0069940 entitled “Ultrasonic Device for Fingertip Control,” published Mar. 18, 2010, the disclosure of which is incorporated by reference herein. Similarly, various ways in which medical devices may be adapted to include a portable power source are disclosed in U.S. Provisional Application Ser. No. 61/410,603, filed Nov. 5, 2010, entitled “Energy-Based Surgical Instruments,” the disclosure of which is incorporated by reference herein.

Many medical devices may be used during internal operations on a patient. During these operations, bodily fluids, such as blood, and tissue may come into contact with the medical device. Once blood or tissue comes into contact with the medical device, the device may lose its sterility and may be contaminated. Moreover, if the housing of a medical device does not seal properly, bodily fluids may seep into the device and may contaminate the components within. For one-time use medical devices or components this may not be an issue since the device may be disposed of. However, for a medical device with high value components, the ability to reuse or reprocess those high value components may increase the value of the initial purchase by possibly spreading the cost of those components over multiple uses. Alternatively, reclamation of the components may avoid any environmental issues regarding the disposal of the components.

While several systems and methods have been made and used for packaging a reclaimable component of a medical device, it is believed that no one prior to the inventors has made or used the invention described in the appended claims.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a schematic view of an exemplary medical device having an internal power source;

FIG. 2 depicts a perspective view of an exemplary medical device having an internal power source;

FIG. 3A depicts a side cross-sectional view of an exemplary package for an insertable electrical component;

FIG. 3B depicts a side cross-sectional view of the package of FIG. 3A, showing the attachment of the insertable electrical component into a medical device

FIG. 3C depicts a side cross-sectional view of the package of FIG. 3A, showing the exemplary package with an exemplary lid for reclamation;

FIG. 4 depicts a partial side cross-sectional view of a securing boss of a reclamation lid and an insertion portion of an insertable electrical component;

FIG. 5A depicts a perspective view of an insertable electrical component having a plurality of sterile films;

FIG. 5B depicts a perspective view of the exemplary insertable electrical component of FIG. 5A, showing the insertable electrical component inserted into an exemplary medical device;

FIG. 5C depicts a perspective view of the exemplary insertable electrical component of FIG. 5A, showing one of the plurality of sterile films being removed;

FIG. 6 depicts a cross-sectional view of an exemplary medical device having sealed internal electrical components;

FIG. 7 depicts an exploded perspective view of the exemplary medical device and components of FIG. 6, showing the removal of the internal electrical components for reclamation;

FIG. 8 depicts an exploded perspective view of another example of a sealed internal electrical component;

FIG. 9 depicts a rear view of an exemplary medical device having a discharge port; and

FIG. 10 depicts a perspective view of an exemplary reclamation container with the medical device of FIG. 9 inserted.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

I. Overview of Exemplary Medical Devices

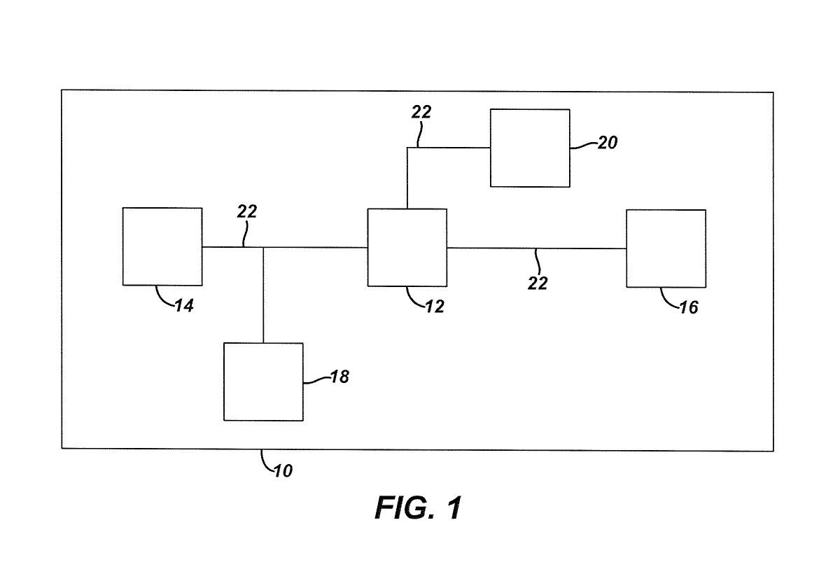

FIG. 1 shows components of an exemplary medical device (10) in diagrammatic block form. As shown, medical device (10) comprises a control module (12), a power source (14), and an end effector (16). Merely exemplary power sources (14) may include NiMH batteries, Li-ion batteries (e.g., prismatic cell type lithium ion batteries, etc.), Ni-Cad batteries, or any other type of power source as may be apparent to one of ordinary skill in the art in light of the teachings herein. Control module (12) may comprise a microprocessor, an application specific integrated circuit (ASIC), memory, a printed circuit board (PCB), a storage device (such as a solid state drive or hard disk), firmware, software, or any other suitable control module components as will be apparent to one of ordinary skill in the art in light of the teachings herein. Control module (12) and power source (14) are coupled by an electrical connection (22), such as a cable and/or traces in a circuit board, etc., to transfer power from power source (14) to control module (12). Alternatively, power source (14) may be selectively coupled to control module (12). This allows power source (14) to be detached and removed from medical device (10), which may further allow power source (14) to be readily recharged or reclaimed for resterilization and reuse, such as in accordance with the various teachings herein. In addition or in the alternative, control module (12) may be removed for servicing, testing, replacement, or any other purpose as will be apparent to one of ordinary skill in the art in view of the teachings herein.

End effector (16) is coupled to control module (12) by another electrical connection (22). End effector (16) is configured to perform a desired function of medical device (10). By way of example only, such function may include cauterizing tissue, ablating tissue, severing tissue, ultrasonically vibrating, stapling tissue, or any other desired task for medical device (10). End effector (16) may thus include an active feature such as an ultrasonic blade, a pair of clamping jaws, a sharp knife, a staple driving assembly, a monopolar RF electrode, a pair of bipolar RF electrodes, a thermal heating element, and/or various other components. End effector (16) may also be removable from medical device (10) for servicing, testing, replacement, or any other purpose as will be apparent to one of ordinary skill in the art in view of the teachings herein. In some versions, end effector (16) is modular such that medical device (10) may be used with different kinds of end effectors (e.g., as taught in U.S. Provisional Application Ser. No. 61/410,603, etc.). Various other configurations of end effector (16) may be provided for a variety of different functions depending upon the purpose of medical device (10) as will be apparent to those of ordinary skill in the art in view of the teachings herein. Similarly, other types of components of a medical device (10) that may receive power from power source (14) will be apparent to those of ordinary skill in the art in view of the teachings herein.

Medical device (10) of the present example includes a trigger (18) and a sensor (20), though it should be understood that such components are merely optional. Trigger (18) is coupled to control module (12) and power source (14) by electrical connection (22). Trigger (18) may be configured to selectively provide power from power source (14) to end effector (16) (and/or to some other component of medical device (10)) to activate medical device (10) when performing a procedure. Sensor (20) is also coupled to control module (12) by an electrical connection (22) and may be configured to provide a variety of information to control module (12) during a procedure. By way of example only, such configurations may include sensing a temperature at end effector (16) or determining the oscillation rate of end effector (16). Data from sensor (20) may be processed by control module (12) to effect the delivery of power to end effector (16) (e.g., in a feedback loop, etc.). Various other configurations of sensor (20) may be provided depending upon the purpose of medical device (10) as will be apparent to those of ordinary skill in the art in view of the teachings herein. Of course, as with other components described herein, medical device (10) may have more than one sensor (20), or sensor (20) may simply be omitted if desired.

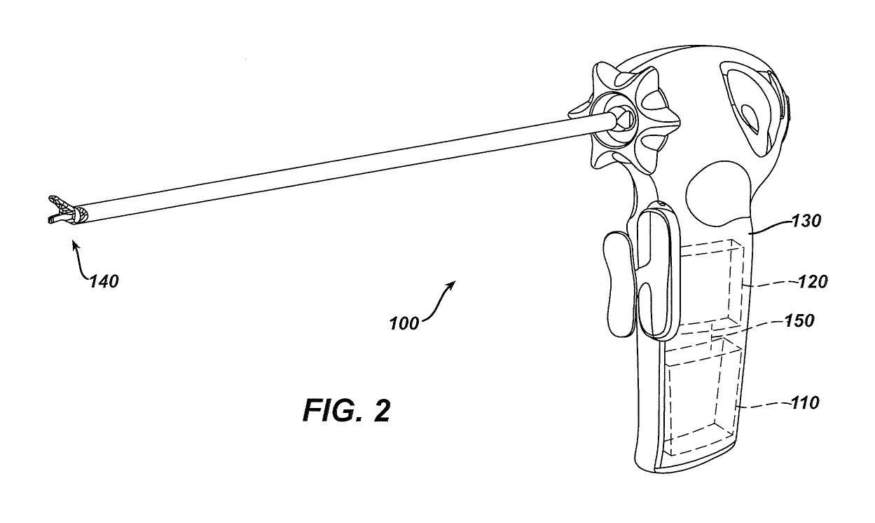

FIG. 2 depicts a merely exemplary form that medical device (10) may take. In particular, FIG. 2 shows a medical device (100) comprising a power source (110), a control module (120), a housing (130), end effector (140), and an electrical connection (150). In the present example, power source (110) is located internally within housing (130) of medical device (100). Alternatively, power source (110) may only partially extend into housing (130) and may be selectively attachable to a portion of housing (130). In yet a further exemplary configuration, a portion of housing (130) may extend into power source (110) and power source (110) may be selectively attachable to the portion of housing (130). Power source (110) may also be configured to detach from medical device (100) and decouple from control module (120) or electrical connection (150). As a result, power source (110) may be completely separated from medical device (100) in some versions. As is readily apparent, this may allow the power source (110) to be removed to be recharged or reclaimed for resterilization and reuse, such as in accordance with various teachings herein. After recharging, or after an initial charge, power source (110) may be inserted or reinserted into medical device (100) and secured to housing (130) or internally within housing (130). Of course, medical device (100) may also allow power source (110) to be charged and/or recharged while power source (110) is still in or otherwise coupled relative to housing (130).

It should also be understood that control module (120) may be removed for servicing, testing, replacement, or any other purpose as will be apparent to one of ordinary skill in the art in view of the teachings herein. Further, end effector (140) may also be removable from medical device (100) for servicing, testing, replacement, or any other purpose as will be apparent to one of ordinary skill in the art in view of the teachings herein. While certain configurations of an exemplary medical device (100) have been described, various other ways in which medical device (100) may be configured will be apparent to those of ordinary skill in the art in view of the teachings herein. By way of example only, medical devices (10, 100) and/or any other medical device referred to herein may be constructed in accordance with at least some of the teachings of U.S. Pat. No. 6,500,176; U.S. Pat. No. 7,416,101; U.S. Pat. No. 7,738,971; U.S. Pub. No. 2006/0079874; U.S. Pub. No. 2007/0191713; U.S. Pub. No. 2007/0282333; U.S. Pub. No. 2008/0200940; U.S. Pub. No. 2009/0209990; U.S. Pub. No. 2010/0069940; and/or U.S. Provisional Application Ser. No. 61/410,603.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should also be understood that various teachings herein may be readily combined with various teachings in any of the following patent applications, all of which are filed on even date herewith and the disclosures of all of which are incorporated by reference herein: U.S. patent application Ser. No. [Attorney Docket No. END6895USNP.0581496], entitled “Medical Device Packaging with Charging Interface”; U.S. patent application Ser. No. [Attorney Docket No. END6895USNP1.0581500], entitled “Motor Driven Electrosurgical Device with Mechanical and Electrical Feedback”; U.S. patent application Ser. No. [Attorney Docket No. END6895USNP3.0581538], entitled “Sterile Housing for Non-Sterile Medical Device Component”; U.S. patent application Ser. No. [Attorney Docket No. END6895USNP4.0581540], entitled “Sterile Medical Instrument Charging Device”; U.S. patent application Ser. No. [Attorney Docket No. END6895USNP5.0581543], entitled “Medical Device Packaging with Window for Insertion of Reusable Component”; U.S. patent application Ser. No. [Attorney Docket No. END6895USNP6.0581545], entitled “Medical Device with Feature for Sterile Acceptance of Non-Sterile Reusable Component”; and U.S. patent application Ser. No. [Attorney Docket No. END6902USNP.0581498], entitled “Sterile Package System for Medical Device.” Various suitable ways in which teachings herein may be combined with teachings of the above-referenced patent applications, as well as various ways in which teachings of the above-referenced patent applications may be combined together with or without teachings herein, will be apparent to those of ordinary skill in the art.

II. Packaging and Configurations for Insertable Electrical Components for Aseptic Transfer for Installation and Reclamation

For a medical device with high value components, the ability to reuse or reprocess these high value components may increase the value of the initial purchase by spreading the cost of those components over multiple uses. Alternatively, if environmental restrictions limit the disposal of certain components, the ability ship those components back to a manufacturer for recycling or proper disposal may avoid potential environmental issues for the user. Instances of components that may not necessarily be disposable include batteries or battery packs, components containing heavy metals, or radioactive materials. Accordingly, the following examples relate to various illustrative ways to package or configure insertable electrical components for installation and reclamation.

A. Packaging for Installation and Reclamation of an Insertable Electrical Component

On occasion it may be useful to keep electrical components separate from a medical device before and after using the medical device. One such occasion where this may be useful is to keep a power source, such as a battery, separated to prevent discharge while the medical device is not in use. It may further also be useful to maintain a sterile environment before use and to prevent contamination from a used component after use. Accordingly, some exemplary containers for maintaining an initial sterile environment prior to use and for preventing contamination by a used device during reclamation are provided below.

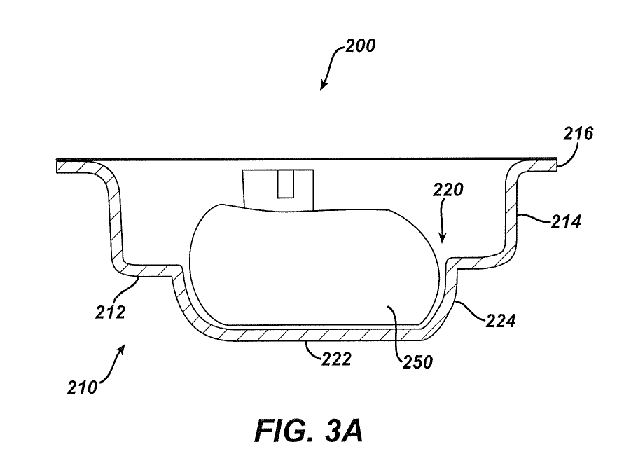

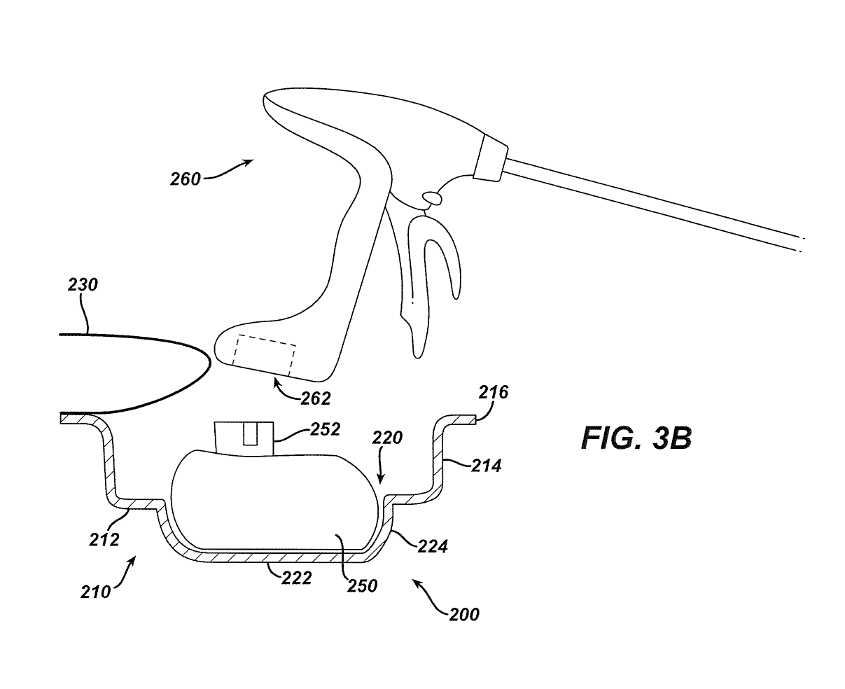

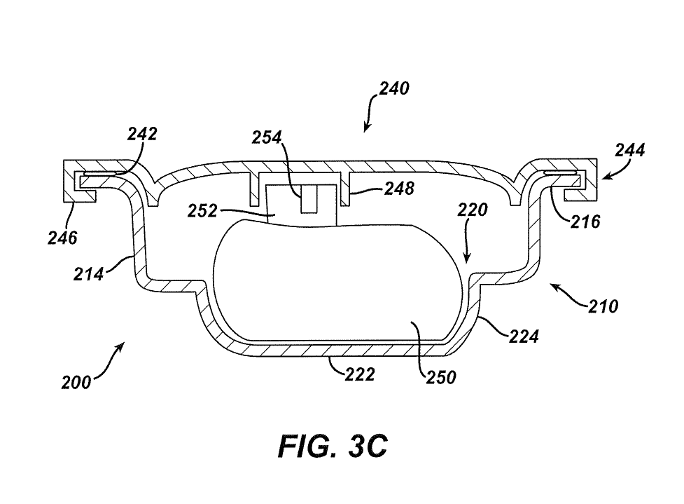

FIGS. 3A-3C show a side cross-sectional view of an exemplary container (200) for installation and reclamation of an insertable electrical component (250). Container (200) comprises a container base (210) a container cover (230) and a reclamation lid (240). Container base (210) comprises a rim (216), a plurality of sidewalls (214), and a container bottom (212). Container base (210) of the present example further comprises a recess (220) defined by recess sidewalls (224) and recess bottom (222), though it should be understood that recess (220) is merely optional. In the present example, recess (220) is formed to substantially conform to the profile of the insertable electrical component (250) such that the insertable electrical component (250) is limited to vertical extraction and insertion. Container base (210) may be a single homogeneous continuous piece, such as a blister tray, and may be made from a variety of materials including plastics, polyethylene terephthalate glycol (or PETG), other thermoplastic polymer resins, or any other suitable rigid or semi-rigid material to maintain sterility. Various other suitable ways to configure container base (210) for use with an insertable electrical component (250) will be apparent to those of ordinary skill in the art in view of the teachings herein.

Container cover (230) is attached or secured to container base (210) at rim (216). In the present example, container cover (230) is a plastic peelable film adhesively attached to rim (216) to seal container (200) prior to use. Alternatively, container cover (230) may be heat sealed to rim (216). In yet another alternative, container cover (230) may be a rigid cover that is configured to snap on, screw on, or attach by any other mechanical attachment to rim (216) as will be apparent to those of ordinary skill in the art in view of the teachings herein. Container cover (230) may also be made from a variety of materials including plastics, plastic peelable films, high density polyethylene fiber materials (such as Tyvek® of E. I. du Pont de Nemours and Company of Wilmington, Del.), or any other suitable material to maintain sterility. While only a few exemplary container lid configurations have been described, other various configurations may be provided as will be apparent to those of ordinary skill in the art in view of the teachings herein.

Initially, an insertable electrical component (250) is inserted into recess (220) of container base (210). By way of example only, insertable electrical component (250) may comprise a power source, such as one of the types of batteries previously discussed herein, a plurality of batteries in the form of a battery pack, a printed circuit board, and/or any other electrical component or combination of electrical components as will be apparent to those of ordinary skill in the art in view of the teachings herein. If insertable electrical component (250) comprises a power source, the power source may contain some initial electrical charge when initially inserted into container base (210). Container cover (230) is then attached to rim (216) to seal container (200) for transport to a user. In some versions, sealed container (200) is further placed in one or more other containers for shipping to the end user, and is then removed from such one or more other containers before use by the end user. For instance, sealed container may be double bagged in plastic film and then be shipped in a protective case that substantially prevents cover (230) from coming off and/or being punctured/perforated during transport. Other suitable shipping structures, configurations, and methods will be apparent to those of ordinary skill in the art in view of the teachings herein. An exemplary container (200) is shown in FIG. 3A in a ready-to-use state.

When the user desires to use the insertable electrical component (250) with a medical device (260), the user detaches container cover (230) from rim (216). Medical device (260) may constructed in accordance with at least some of the teachings of medical devices (10) or (100) as previously described herein, or medical device (260) may have any other suitable configuration. In one exemplary configuration, the user peels off container cover (230), as shown in FIG. 3B, thereby allowing access to the insertable electrical component (250). Alternatively, the user may unscrew, unsnap, or detach container cover (230) if container cover (230) is mechanically attached to container base (210). For insertion of insertable electrical component (250), insertable electrical component (250) has an insertion portion (252) that corresponds to a receiving recess (262) of medical device (260). In this configuration, a user lowers receiving recess (262) on to insertion portion (252) to attach insertable electrical component (250) to medical device (260). This may allow a user to avoid handling insertable electrical component (250) when connecting insertable electrical component (250) to the medical device (260). In one exemplary configuration, insertion portion (252) may attach to receiving recess (262) by a pair of resiliently biased retention pieces (not shown) in receiving recess (262) that insert into corresponding recesses on insertion portion (252) when insertion portion (252) is inserted into receiving recess (262). A release mechanism (not shown) may also be attached to the retention pieces such that a user may operate the release mechanism to compress the resiliently biased retention pieces to release and detach insertion portion (252). Various other suitable attachment and release mechanisms for use with insertable electrical component (250) will be apparent to those of ordinary skill in the art in view of the teachings herein.

Once the user is finished using medical device (260), insertable electrical component (250) is returned to container (200). In the present example, insertable electrical component (250) is dropped into the container base (210) by releasing insertable electrical component (250) by a release mechanism (not shown) above the recess (220), thereby limiting potential contamination from the used insertable electrical component (250) on the exterior of container (200) or anywhere else. When used insertable electrical component (250) is returned to recess (220), an exemplary reclamation lid (240), as shown in FIG. 3C, is attached to container (200) to reseal container (200) for transport to reclaim and reprocess insertable electrical component (250). By way of example only, reclamation lid (240) may be used if container cover (230) is a disposable or one-time use cover. Alternatively, if container cover (230) is a resealable plastic peelable film or a resealable rigid cover, container cover (230) may be reused to reseal container (200). Reclamation lid (240) of the present example comprises a lid attachment portion (244), a seal (242), and a securing boss (248), though it should be understood that seal (242) and securing boss (248) are merely optional. As shown in FIG. 3C, one exemplary lid attachment portion (244) provides a snap-on attachment comprising a resilient horizontally-oriented U-shaped member (246). When reclamation lid (240) is aligned with container base (210), the user presses upon reclamation lid (240). Lid attachment portion (244) slightly deforms until rim (216) snaps into lid attachment portion (244). Reclamation lid (240) may alternatively include a variety of other lid attachment portions (244) examples of which include a screw-on attachment, a friction fit attachment, or other various configurations as will be apparent to those of ordinary skill in the art in view of the teachings herein.

In the present example, seal (242) is included to hermetically seal container (200). Seal (242) is sized to substantially conform to the size and shape of rim (216). Seal (242) may be made from a variety of materials, including natural rubber, silicone, neoprene, Polytetrafluoroethylene (or PTFE), or other suitable sealing materials as will be apparent to those of ordinary skill in the art in view of the teachings herein. When reclamation lid (240) of the present example is snapped on to rim (216) of container base (210), lid attachment portion (244) compresses seal (242) to securely close and hermetically seal container (200).

Reclamation lid (240) of the present example further includes a securing boss (248). As shown in FIG. 3C, securing boss (248) comprises a protrusion of homogeneous continuous material from the bottom of reclamation lid (240). Securing boss (248) is sized and located to correspond to insertion portion (252) of insertable electrical component (250) when insertable electrical component (250) is within recess (220). Securing boss (248) may be configured to completely surround the sides of insertion portion (252) or, alternatively, a plurality of securing bosses (248) may extend from the bottom of reclamation lid (240). In the present example, two securing bosses (248) are shown in FIG. 3C extending from the bottom of reclamation lid (240) to secure insertion portion (252).

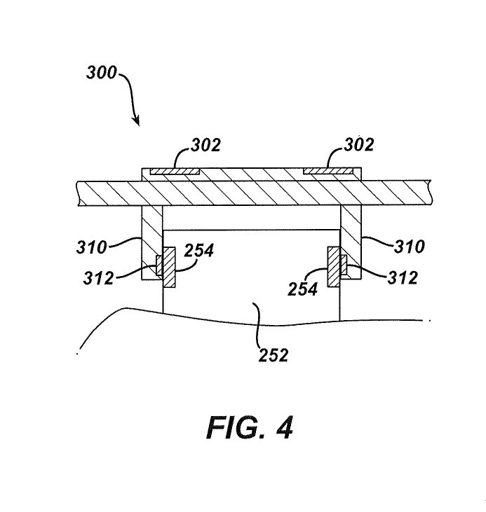

Referring to FIG. 4, an alternative exemplary reclamation lid (300) is provided for container (200). Reclamation lid (300) comprises a lid attachment portion (not shown), external contacts (302), and a securing boss (310). The lid attachment portion of reclamation lid (300) may be constructed in accordance with lid attachment portion (244) as previously described herein or in accordance with any other suitable lid attachment configuration as will be apparent to one of ordinary skill in the art in light of the teachings herein. Securing boss (310) may be configured to completely surround insertion portion (252) thereby forming a single continuous protrusion from the bottom of reclamation lid (300), or, alternatively, a plurality of securing bosses (310) may extend from the bottom of reclamation lid (300). In the present example, two securing bosses (310) are shown in FIG. 4 extending from the bottom of reclamation lid (300) to secure insertion portion (252) of insertable electrical component (250).

Securing boss (300) of the present example further comprises boss contacts (312) to electrically couple to corresponding electrical contacts (254) on insertion portion (252) of insertable electrical component (250). Boss contacts (312) on securing boss (310) of the present example are connected to external contacts (302) on top of reclamation lid (300), though it should be understood that external contacts (302) may be positioned at any location on reclamation lid (300). External contacts (302) may be used for charging, recharging, or running diagnostic tests on insertable electrical component (250) while it is within container (200). Alternatively, external contacts (302) may be used for connection to a resistive load, an example of which is described herein as discharge device (760), to dissipate any remaining charge of insertable electrical component (250) prior to shipment for reclamation. In yet another alternative, the resistive load may be mounted to reclamation lid (300) or embedded within reclamation lid (300) and connected to the boss contacts (312) to dissipate any remaining electrical charge of insertable electrical component (250) while container (200) is shipped back for reclamation. It should be noted that the teachings herein with respect to reclamation container (700), described below, may be readily incorporated into reclamation lid (300), including, but not limited to, a discharge device (760), a plurality of electrical connections (762), and/or a discharge plug (764). While a variety of configurations for securing boss (300) have been described, various other implementations and configurations of securing boss (300) may be provided as will be apparent to those of ordinary skill in the art in view of the teachings herein.

It should be understood that reclamation lid (200) and reclamation lid (300) are interchangeable and may both be used with container (200). Once reclamation lid (240) or reclamation lid (300) is securely attached to container base (210) with a used insertable electrical component (250) contained therein, container (200) may then be shipped back for reprocessing, resterilization, and/or reuse as will be apparent to those of ordinary skill in the art in view of the teachings herein.

While various configurations of container (200) have been described, various other configurations may be provided as will be apparent to those of ordinary skill in the art in view of the teachings herein.

B. Configuration for a Partially Exposed Insertable Electrical Component for Installation and Reclamation

During a medical procedure bodily fluids may come into contact with the medical device, and, more specifically, with the exposed components. To maximize the number of uses for those partially exposed components, a removable exterior protection layer may be used to avoid contamination of the underlying component. By using multiple exterior protective layers, the component may be reused a number of times before needing to be resterilized or reclaimed.

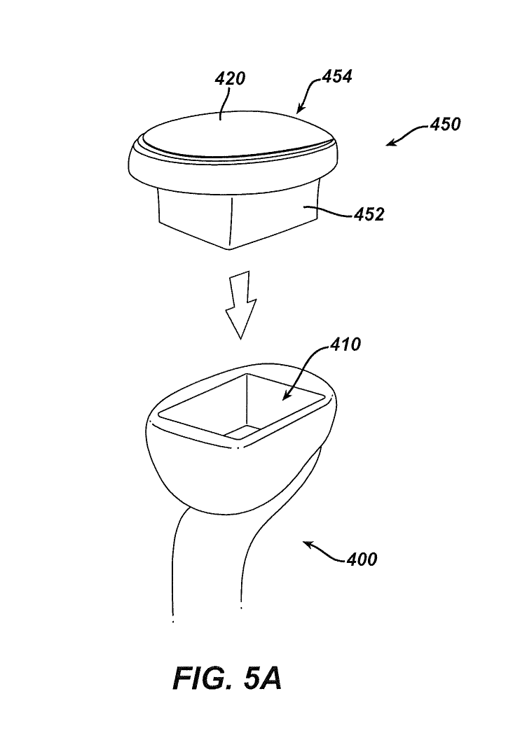

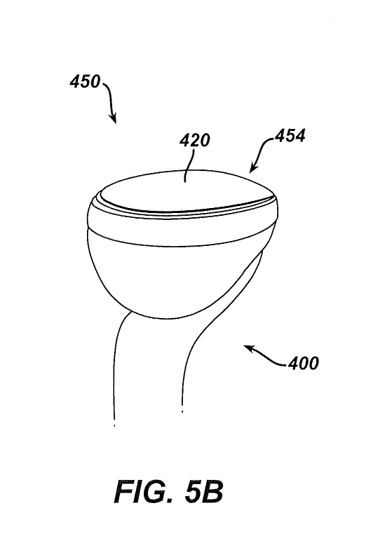

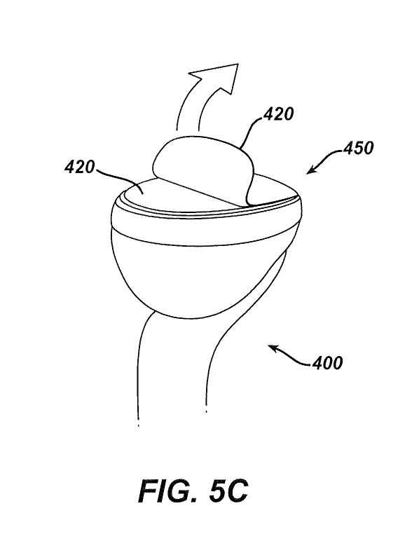

FIGS. 5A-5C show an exemplary configuration for an insertable electrical component (450). Insertable electrical component (450) of the present example comprises an insertion portion (452), a bottom face (454), and a plurality of peelable sterile films (420). By way of example only, insertable electrical component (450) may comprise a power source, such as one of the types of batteries previously discussed herein, a plurality of batteries in the form of a battery pack, a printed circuit board, and/or any other electrical component or combination of electrical components as will be apparent to those of ordinary skill in the art in view of the teachings herein. The plurality of peelable sterile films (420) of the present example are attached to bottom face (454), though as one of ordinary skill in the art can appreciate, the plurality of peelable sterile films (420) may be attached to other locations on insertable electrical component (450) or covering more of insertable electrical component (450) than the bottom face (454). An initial peelable sterile film (420) is adhesively attached to bottom face (454) of insertable electrical component (450). Initial peelable sterile film (420) may be marked with a marker (not shown) to indicate the end of the plurality of peelable sterile films (420). Alternatively, bottom face (454) may include a marker (not shown) to indicate when the final peelable sterile film (420) has been removed. Subsequent peelable sterile films (420) are adhesively attached to each preceding peelable sterile film (420) until a desired number has been reached, for example, 50 layers. A protective film (not shown) may be adhesively attached to the last peelable sterile film (420) to protect the underlying peelable sterile films (420) during transport and before the initial use. By way of example only, one alternative configuration may comprise a protective film (not shown) between each successive peelable sterile film (420). Various other suitable attachments and arrangements for peelable sterile films (420) may be provided as will be apparent to those of ordinary skill in the art in view of the teachings herein.

Each layer of peelable sterile film (420) is impregnated with one or more substances that change color when exposed to air or other ambient conditions in an operating room or other location. By way of example only, such substances may include photochromatic compounds, thermochromatic compounds, gasochromatic compounds, trace amounts of oxidizing metals, etc., such that a newly exposed peelable sterile film (420) changes color in response to light, temperature, oxygen, nitrogen, carbon dioxide, etc. to indicate that layer of peelable sterile film (420) may no longer be sterile. By way of example only, each layer of peelable sterile film (420) comprises a clear plastic film such that when the one or more substances are not activated, peelable sterile film (420) appears as clear to the user. Thus, when the user views bottom face (454) of insertable electrical component (450), the coloring of insertable electrical component (450) is seen, such as a white coloring. Once the one or more substances are activated, the top layer of peelable sterile film (420) changes to an opaque film, such as a blue opaque color, to indicate that the top layer of peelable sterile film (420) may no longer be sterile. Alternatively, the top layer of peelable sterile film (420) may remain clear but be tinted to a color different from the coloring of insertable electrical component (450) to indicate that the top layer of peelable sterile film (420) may no longer be sterile. Various other suitable reactive compounds and configurations may be used with peelable sterile film (420) as will be apparent to those of ordinary skill in the art in view of the teachings herein.

As shown in FIG. 4A, insertion portion (452) of insertable electrical component (450) may be inserted into a receiving recess (410) of a medical device (400). Medical device (400) may constructed in accordance with at least some of the teachings of medical devices (10) or (100) as previously described herein, or medical device (400) may have any other suitable configuration as will be apparent to one of ordinary skill in the art in light of the teachings herein. Once insertable electrical component (450) is inserted, the protective film (not shown), if included, may be removed to expose the first peelable sterile film (420). FIG. 4B depicts insertable electrical component (450) as inserted in medical device (400) with an exemplary peelable sterile film (420) exposed. After a user is finished operating medical device (400) for one procedure, the exposed peelable sterile film (420) is removed to expose a new peelable sterile film (420), as shown in FIG. 4C. When exposed to light, temperature, oxygen, nitrogen, carbon dioxide, etc. the photochromatic compounds, thermochromatic compounds, gasochromatic compounds, trace amounts of oxidizing metals, etc. in peelable sterile film (420) respond with a change the observed color of the exposed peelable sterile film (420), as described above. Alternatively, peelable sterile film (420) may change from a transparent or semi-transparent film into an opaque film.

Insertable electrical component (450) may also be removed from medical device (400) between uses. While removed, insertable electrical component (450) may be inductively or conductively recharged. Insertable electrical component (450) may then be reinserted into medical device (400) after medical device (400) is resterilized. Alternatively, insertable electrical component (450) may be inserted into a new sterile medical device. Once the final peelable sterile film (420) is used, insertable electrical component (450) may be returned for reclamation. By way of example only, insertable electrical component (450) may be returned in container (200) as previously discussed herein. Various other suitable configurations of insertable electrical component (450) and peelable sterile films (420) may be provided as will be apparent to those of ordinary skill in the art in view of the teachings herein.

C. Alternative Exemplary Packaging and Configuration for an Insertable Electrical Component for Installation and Reclamation

On occasion bodily fluids may potentially seep into the casing of a medical device during a procedure, thereby potentially contaminating any components within. If this occurs, the components within the casing may need to be cleaned and/or resterilized before they may be reused, while other components of the medical device may simply be disposed of. Providing a housing to encase the reclaimable components may limit potential contamination of those components and potentially avoiding the need to clean or resterilize those reclaimable components. A contaminated housing may be removed and disposed while retaining the clean component to repackage in a new housing for reuse without necessarily needing resterilization.

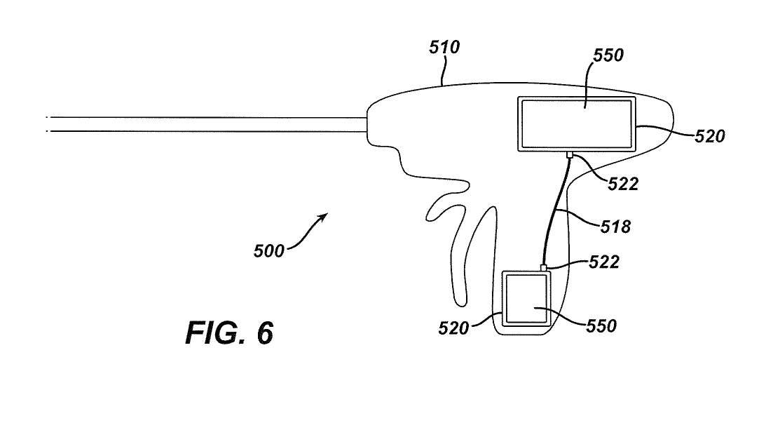

FIG. 6 shows a side cross-sectional view of one such exemplary configuration and packaging for a casing (520). An exemplary medical device (500) may comprise a housing (510) and an insertable electrical component (550) contained within housing (510). Medical device (500) may constructed in accordance with at least some of the teachings of medical device (10) or medical device (100) as previously described herein, or medical device (500) may have any other suitable configuration as will be apparent to one of skill in the art in light of the teachings herein. By way of example only, insertable electrical component (550) may comprise a power source, such as one of the types of batteries previously discussed herein, a plurality of batteries in the form of a battery pack, a printed circuit board, and/or any other electrical component or combination of electrical components as will be apparent to those of ordinary skill in the art in view of the teachings herein.

Insertable electrical component (550) is further encased within casing (520). Casing (520) may be made from a variety of materials to limit potential contamination of insertable electrical component (550) while medical device (500) is in use. In the present example, casing (520) comprises a heat-shrunk plastic blister pack. An alternative casing (520) may comprise a flexible rubber or neoprene casing. Yet a further alternative casing (520) may include a hinged hard plastic clamshell casing. Casing (520) further comprises a protrusion (522) providing an electrical feed-through, through which an electrical connection (518) couples insertable electrical component (550) to another insertable electrical component (550) or to other components of medical device (500), though it should be understood that protrusion (522) is merely optional. Protrusion (522) of the present example comprises a heat-shrunk portion of plastic extending from casing (520). Alternatively, protrusion (522) may comprise an elastomeric component (not shown) having a through hole. Example of such elastomeric component may include a rubber nipple with an aperture, a silicone plug with a through hole, an EPDM rubber plug with a through hole, a rubber grommet, or any other elastomeric component with a through hole as will be apparent to those of ordinary skill in the art in light of the teachings herein. Additionally, while various exemplary casings (520) have been described, various other ways in which casings (520) may be configured will be apparent to those of ordinary skill in the art in view of the teachings herein.

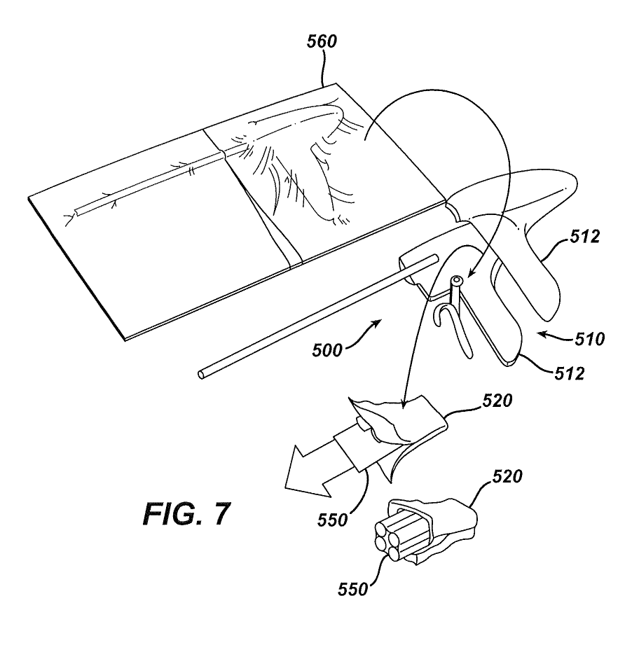

Referring to FIG. 7, initially medical device (500) is sent to a user in a package (560). The user then removes medical device (500) from package (560) for use in a procedure. After the user has finished using medical device (500), housing (510) is opened. In the current example, housing (510) comprises two half shell portions (512). Half shell portions (512) are attached together to while medical device (500) is in use and are separable once reclamation of insertable electrical component (550) is desired. Merely exemplary attachments to attach half shell portions (512) together include snap-on fittings, friction fittings, screws, bolt and nut combinations, or any other suitable attachment as will be apparent to one of skill in the art in view of the teachings herein. Alternatively, medical device (500) may comprise a frame (not shown) and detachable sections (not shown). The detachable sections may be removed to access only selected areas of the interior of medical device (500) that correspond to the locations of insertable electrical components (550). Once housing (510) is opened, insertable electrical component (550) within casing (520), shown as a bubble pack in the present example, is removed from housing (510). Casing (520) is then opened to expose insertable electrical component (550). Insertable electrical components (550) may further be detached from any electrical connections (518) coupled to insertable electrical component (550). Insertable electrical component (550), which is still clean or sterile due to the protection provided by casing (520) during use of medical device (500), may then be repackaged in a new casing (520) and reused with a new medical device without needing to be resterilized and/or cleaned. Alternatively, insertable electrical component (550) may be sent for further processing (e.g., recharging, testing, and/or reconditioning). With insertable electrical component (550) removed, the remainder of the used device may be properly disposed of.

While various configurations of casing (520) have been described, various other ways to configure casing (520) may be provided as will be apparent to those of ordinary skill in the art in view of the teachings herein.

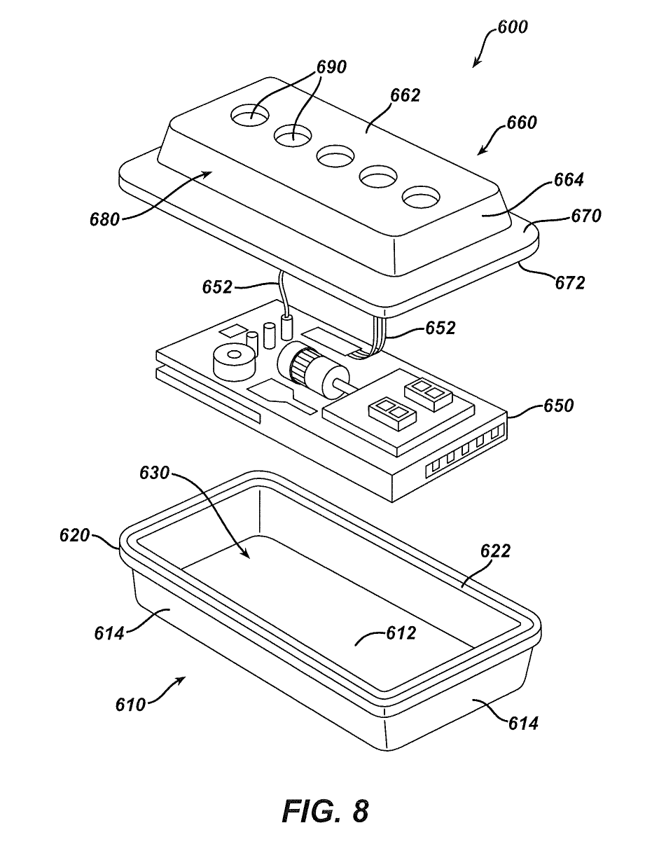

FIG. 8 depicts an alternative exemplary casing (600). Casing (600) of the present example comprises a bottom member (610), an insertable electrical component (650), and a top member (660). Insertable electrical component (650) may comprise a power source, such as one of the types of batteries previously discussed herein, a plurality of batteries in the form of a battery pack, a printed circuit board, and/or any other electrical component or combination of electrical components as will be apparent to those of ordinary skill in the art in view of the teachings herein. Bottom member (610) comprises a base (612) and sidewalls (614), the sidewalls (614) collectively defining a recess (630). Bottom member (610) of the present example further comprises a bottom rim (620) extending outwardly from sidewalls (614) and a seal (622) attached to a top surface of bottom rim (620), though it should be understood that such components are merely optional. Bottom member (610) may be made from a variety of rigid or semi-rigid materials including, but not limited to, plastics, thermoplastics, vulcanized rubber, or any other material may be provided as will be apparent to those of ordinary skill in the art in view of the teachings herein. In the present example, bottom member (610) is sized and configured to accommodate insertable electrical component (650) at least partially within recess (630). Alternatively, bottom member (610) may be sized to conform to the contours of the interior of a medical device, such as one constructed in accordance with at least some of the teachings herein relating to medical device (10) or medical device (100), while still accommodating part of insertable electrical component (650) therein.

Top member (660) comprises a top surface (662) and sidewalls (664), the sidewalls (664) collectively defining a top recess (680). Top member (660) may be made from a variety of rigid or semi-rigid materials including, but not limited to, plastics, thermoplastics, vulcanized rubber, or any other material may be provided as will be apparent to those of ordinary skill in the art in view of the teachings herein. Top member (660) of the present example is sized and configured to accommodate insertable electrical component (650) at least partially within top recess (680). Alternatively, by way of example only, top member (660) may be sized to conform to the contours of the interior of a medical device, such as one constructed in accordance with at least some of the teachings herein relating to medical device (10), medical device (100), or any other medical device described herein, while still accommodating part of insertable electrical component (650) therein.

Top recess (680) of the present example further comprises a plurality of exterior contacts (690). As shown in FIG. 8, exterior contacts (690) are round metallic contacts recessed within top surface (662). Alternatively, exterior contacts (690) may comprise a protrusion (not shown) having female electrical connectors (not shown) in receptacles (not shown) forming a female plug. In yet another alternative, exterior contacts (690) may comprise a plurality of metallic cylindrical pins (not shown) extending outwardly from top surface (662). Other various configurations for exterior contacts (690) may be provided as will be apparent to one of ordinary skill in the art in light of the teachings herein. Exterior contacts (690) are also electrically coupled to electrical connection (652). Exterior contacts (690) may have male metallic pins (not shown) protruding into the interior of recess (680) to which a first end of electrical connection (652) may be electrically coupled. Alternatively, the first end of electrical connection (652) may be securely attached and electrically coupled to exterior contacts (690) and a portion of electrical connection (652) may be embedded within top surface (662) such that electrical connection (652) is not separable from top member (660). The second end of electrical connection (652) of the present example is configured to electrically couple to insertable electrical component (650). It should be understood that a plurality of electrical connections (652) may also be used and electrically coupled to the plurality of exterior contacts (690). While various exemplary configurations for exterior contacts (690) and electrical connection (652) have been described, various other configurations for exterior contacts (690) and electrical connection (652) may be provided as will be apparent to those of ordinary skill in the art in view of the teachings herein.

In the current example, top member (660) further comprises a top rim (670), though it should be understood that this is merely optional. Top rim (670) extends outwardly from sidewalls (664) and further comprises an attachment member (672) along the perimeter of top rim (670). Attachment member (672) may be sized and configured to detachably attach top member (660) to rim (620). By way of example only, attachment member (672) may be constructed in accordance with at least some of the teachings herein relating to lid attachment portion (244) or any other attachment portion. Examples of alternative attachment members (672) include a snap-on attachment member, a screw-on attachment member, a friction fit attachment member, or other various mechanical attachments as will be apparent to those of ordinary skill in the art in view of the teachings herein.

When an insertable electrical component (650) is to be used with casing (600), insertable electrical component (650) is electrically coupled to the second end of electrical connection (652). The first end of electrical connection (652) may then be electrically coupled to exterior contacts (690) if first end of electrical connection (652) is not permanently attached. Insertable electrical component (650) is then placed within recess (630). Top rim (670) of top member (660) is then substantially aligned with rim (620) of bottom member (610). Top member (660) is then attached to bottom member (610) with insertable electrical component (650) contained therein. Such attachment may include snap-on attachment, screw-on attachment, friction fit attachment, or any other mechanical attachment accomplished by attachment member (672). Alternatively, top member (660) and bottom member (610) may be adhesively attached, heat sealed together, welded, or any other kind of attachment as will be apparent to one of skill in the art in light of the teachings herein. When top rim (670) and rim (620) are compressed together by attachment member (672), seal (622), as provided in the present example, is compressed to hermetically seal insertable electrical component (650) within casing (600). With insertable electrical component (650) contained within casing (600), exterior contacts (690) are utilized to connect to insertable electrical component (650). Merely exemplary uses for exterior contacts (690) include communicating with a circuit board, testing a circuit board, charging and/or recharging a power source, performing diagnostic electrical load testing on a power source, programming reprogrammable microcontrollers, and/or any other suitable use for exterior contacts (690) as will be apparent to one of skill in the art in view of the teachings herein. It should further be noted that exterior contacts (690) may be used before, during, and/or after use of a medical device using casing (600) to perform a variety of tasks, such as those described above. With insertable electrical component (650) in satisfactory condition, casing (600) is then inserted into and used with a medical device. Exterior contacts (690) permit electrical connection of insertable electrical component (650) with other components in the medical device while casing (600) prevents potential contamination of insertable electrical component (650) by any bodily fluids that may seep into the medical device.

Merely exemplary uses of exterior contacts (690) while casing (600) is inserted in a medical device may include controlling other components of the medical device, providing power to the medical device, and/or monitoring and testing other components in the medical device.

Once a user is finished with the medical device and wants to recover insertable electrical component (650), the user may disassemble the medical device to expose casing (600) therein. By way of example only, one such deconstructable medical device is medical device (500) as previously described herein. Casing (600) may then be removed from the medical device and exterior contacts (690) may be utilized to charge, recharge, reprogram, or test, insertable electrical component (650) contained therein. If insertable electrical component (650) is to be reclaimed or removed from casing (600), then top member (660) and bottom member (610) may be detached and separated to expose insertable electrical component (650). In the present example, top member (660) and bottom member (610) are detached by unsnapping attachment member (672). Electrical connection (652) is then decoupled from insertable electrical component (650). Insertable electrical component (650) may then be removed and reused with a new casing (600).

While various configurations of casing (600) have been described, various other configurations for casing (600) may be provided as will be apparent to those of ordinary skill in the art in view of the teachings herein.

III. Reclamation Packaging with Electrical Discharge Device

When a power source or medical device with a power source stored within is to be reclaimed, there may be occasions when the power source still has some residual charge after the medical device has been used. If the power source is not secured properly within a container, it is possible for the power source to shift around during shipment and inadvertently discharge at an undesirable time or rate. This discharge may damage the power source and/or the container in which it is stored. Additionally, when shipping back a medical device still containing a power source within, it may be possible that the rigors of shipment inadvertently activate the device. This may cause damage to the device and/or the container during shipment. Accordingly, it may be useful to have a controlled discharge of the power source by itself or the medical device with a power source contained therein prior to or during shipment. The following examples relate to illustrative ways in which a medical device may be packaged for reclamation to regulate the electrical discharge prior to or during shipment.

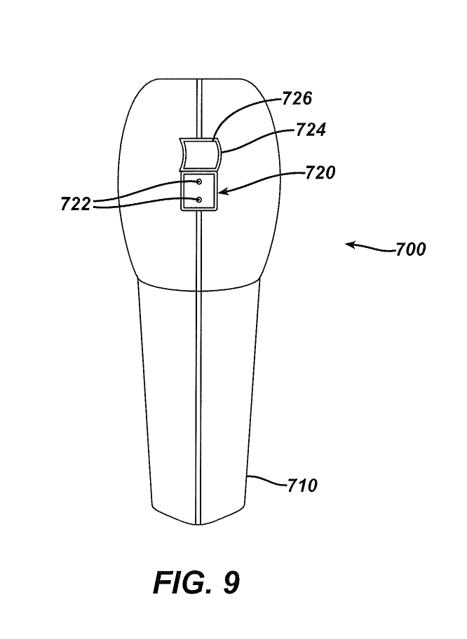

FIG. 9 shows an exemplary medical device (700) comprising a housing (710) and a discharge port (720) having a plurality of discharge contacts (722). Medical device (700) may be constructed in accordance with at least some of the teachings herein relating to medical device (10), medical device (100), medical device (500), or any other suitable medical device as will be apparent to one of skill in the art in light of the teachings herein. Discharge port (720) of the present example is located on the rear of medical device (700) and is recessed within the rear surface of housing (710). It should be understood that discharge port (720) may be located anywhere on medical device (700), including, but not limited to, on the bottom, top, or sides of medical device (700). Furthermore, discharge port (720) need not be recessed within housing (710). In one alternative, discharge port (720) may protrude out from housing (710). By way of example only, a protruding discharge port (720) may be constructed in accordance with at least some of the teachings for external contacts (302) of FIG. 4 or exterior contacts (690) of FIG. 8. In the present example, discharge port (720) has two discharge contacts (722) that are electrically coupled to the positive (cathode) and negative (anode) terminals of a power source (not shown) within medical device (700). It should be understood that there may be more than two discharge contacts (722) and that discharge contacts (722) need not be directly connected to the power source; instead, discharge contacts (722) may be connected to any of the insertable electrical components (not shown) to effectuate discharge of a power source or to discharge any residual charge of those insertable electrical components. Alternatively, discharge contacts (722) need not be limited to discharging insertable electrical components; rather, discharge contacts (722) may be used for a variety of purposes, examples of which include communicating with a circuit board, testing a circuit board, charging and/or recharging a power source, performing diagnostic electrical load testing on a power source, programming reprogrammable microcontrollers, and/or any other suitable use for discharge contacts (722) as will be apparent to one of skill in the art in view of the teachings herein. While various configurations of discharge port (720) have been described, various other configurations for discharge port (720) may be provided as will be apparent to those of ordinary skill in the art in view of the teachings herein.

Discharge port (720) of the present example further comprises a discharge cover (724), though it should be understood that this is merely optional. Discharge cover (724) is sized and configured to selectively cover discharge port (720) such that discharge cover (720) limits potential contact with discharge port (720) or discharge contacts (722) therein. In the current example, a portion of discharge cover (724) is attached to housing (710) to allow discharge cover (720) to be opened without detaching from housing (710); however, discharge cover (724) may be fully detachable from medical device (700). Discharge cover (724) of the present example further includes a ridge (726) that is sized to fit within the recessed portion of discharge port (720) such that ridge (726) further limits potential contact with discharge port (720) or discharge contacts (722) therein. Discharge cover (724) and ridge (726) may be made from a single homogeneous continuum of material and discharge cover (724) and ridge (726) may be rigid, semi-rigid, or flexible. Examples of materials discharge cover (724) and ridge (726) may be created from include plastics, synthetic rubbers, natural rubber, thermoplastic polymers, metals, metal alloys, or any other suitable cover material as will be apparent to those of ordinary skill in the art in view of the teachings herein. It should be understood that if discharge port (720) is formed as a protrusion, then discharge cover (724) may be configured to be a concave piece to fit over the protrusion. While some exemplary configurations of discharge cover (724) have been described, various other ways in which discharge cover (724) may be configured will be apparent to those of ordinary skill in the art in view of the teachings herein.

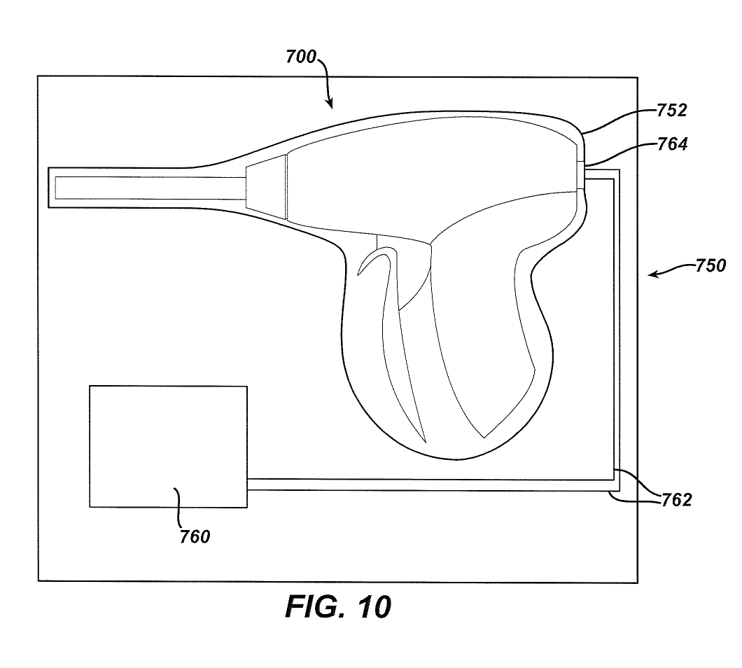

Referring to FIG. 10, when medical device (700) is to be returned for reclamation, medical device (700) is placed within a reclamation container (750). Reclamation container (750) of the present example is shown as a blister tray; however, it should be understood that reclamation container (750) may be formed as a variety of other containers as will be apparent to those of ordinary skill in the art in view of the teachings herein. Reclamation container comprises a first recess (752), a discharge device (760), a plurality of electrical connections (762), and a discharge plug (764). First recess (752) is sized and configured to receive medical device (700) within the recess, though it should be understood that it is merely optional for first recess (752) to substantially conform to the shape of medical device (700). One alternative includes first recess (752) being configured to be a substantially open recess within reclamation container (750). Discharge device (760) of the present example comprises a plurality of resistors (not shown) to dissipate electrical current as heat. Discharge device (760) may further include encasing the plurality of resistors in a heat dissipative casing (not shown). One exemplary heat dissipative casing comprises ceramic material with dissipation fins (not shown) configured to maximize surface heat dissipation. It should be understood that the heat dissipative casing may be made from other materials, including metals or metal alloys, and may be configured in a variety of ways to dissipate heat as will be apparent to one of skill in the art in light of the teachings herein. It should be noted that discharge device (760) is not limited to a heat dissipative device; instead, discharge device (760) may comprise any kind of device which will use the residual charge within a power source. A few merely exemplary alternatives for discharge device (760) include a device that lights up (e.g., a plurality of light emitting diodes), a device that runs a mechanical part (e.g., a motor), or any other device as will be apparent to one of skill in the art in view of the teachings herein. In the present example, discharge device (760) is located in a separate recess in reclamation container (750), though it should be understood that discharge device (760) may be embedded within a compartment in reclamation container (750), located on the outside of reclamation container (750), integrated into a portion of reclamation container (750), or provided in any other configuration as will be apparent to one of skill in the art in light of the teachings herein.

Discharge plug (764) is sized and configured to correspond to discharge port (720) such that when discharge plug (764) is coupled to discharge port (720), discharge contacts (722) electrically couple to electrical contacts (not shown) within discharge plug (764). Electrical connections (762) electrically couple discharge device (760) to discharge plug (764) and form a circuit with discharge device (760) when discharge plug (764) is coupled to discharge port (720). In the present example, discharge plug (764) is mounted to the sidewall of first recess (752) and discharge plug (764) comprises resiliently biased male contacts (not shown). When medical device (700) with exposed discharge port (720) is inserted into first recess (752), the resiliently biased male contacts of discharge plug (764) initially compress as medical device (700) is inserted. Once discharge port (720) and discharge plug (764) align, the resiliently biased male contacts then uncompress and electrically couple to discharge contacts (722) of discharge port (720), thereby forming a circuit between discharge device (760) and a power source within medical device (700), and/or any other insertable electrical components therein. Alternatively, discharge plug (764) may comprise a plug body (not shown) and male electrical protrusions (not shown). This alternative discharge plug (764) may not be mounted to the sidewall of first recess (752); rather, electrical connections (762) may extend beyond the sidewall of first recess (752) such that discharge plug (764) is substantially free to be moved about by a user. Thus, discharge plug (764) is only attached to reclamation container (750) by electrical connections (762) extending there from. In this configuration, discharge plug (764) may be coupled to discharge port (720) prior to inserting medical device (700) into first recess (752). It should be understood that discharge plug (764) may comprise male and/or female electrical connections, discharge plug (764) may comprise a plurality of electrical connections, and the electrical connections may be arranged in any numerical combination of male or female electrical connections or any other configuration as will be apparent to one of skill in the art in light of the teachings herein. While some exemplary configurations of discharge plug (764) have been described, various other ways in which discharge plug (764) may be configured will be apparent to those of ordinary skill in the art in view of the teachings herein.

Once discharge plug (764) and discharge port (720) are coupled and discharge contacts (722) electrically couple to electrical contacts of discharge plug (764) a circuit is formed with discharge device (760). At this time, any residual power within the power source in medical device (700) is dissipated as heat through discharge device (760) in the present example. If other types of discharge devices are provided, any residual charge may be dissipated through the appropriate method for those discharge devices. The discharging of residual charge may be accomplished prior to shipping or done while medical device (700) in reclamation container (750) is en route for reclamation and/or reprocessing.

While various configurations of reclamation container (750) and medical device (700) have been described, various other ways in which reclamation container (750) and medical device (700) may be configured will be apparent to those of ordinary skill in the art in view of the teachings herein.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Embodiments of the present invention have application in conventional endoscopic and open surgical instrumentation as well as application in robotic-assisted surgery.

Embodiments of the devices disclosed herein can be reconditioned for reuse after at least one use. Reconditioning may include any combination of the steps of disassembly of the device, followed by cleaning or replacement of particular pieces, and subsequent reassembly. In particular, embodiments of the devices disclosed herein may be disassembled, and any number of the particular pieces or parts of the devices may be selectively replaced or removed in any combination. Upon cleaning and/or replacement of particular parts, embodiments of the devices may be reassembled for subsequent use either at a reconditioning facility, or by a surgical team immediately prior to a surgical procedure. Those skilled in the art will appreciate that reconditioning of a device may utilize a variety of techniques for disassembly, cleaning/replacement, and reassembly. Use of such techniques, and the resulting reconditioned device, are all within the scope of the present application.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. An apparatus for containing an insertable electrical component of a medical device, the apparatus comprising:
(a) a container base, wherein the container base comprises a container bottom and a plurality of container sidewalls; wherein the container base is sized and configured to receive an insertable electrical component;
(b) a lid, wherein the lid is sized and configured to detachably attach to the container base, and wherein the lid comprises at least one boss protruding downwardly from a bottom surface of the lid; and
(c) a seal, wherein the seal is attached to one of the lid or the container base;
wherein the boss of the lid is configured to substantially restrain the movement of a top portion of an insertable electrical component in at least one direction when an insertable electrical component is inserted into the recess of the container base and the lid is attached to the container base; and
wherein the lid is configured to compress the seal to form a hermetic seal when the lid is attached to the container base, thereby providing a sterile barrier.

2. The apparatus of claim 1, wherein the container bottom further comprises a recess bottom and a plurality of recess sidewalls, the recess sidewalls collectively defining a recess extending upwardly from the container bottom, and wherein the recess is sized and configured to receive an insertable electrical component.

3. The apparatus of claim 1, wherein the at least one boss comprises a single homogeneous continuum of material protruding from the bottom of the lid, and wherein the boss is configured to substantially restrain the movement of a top portion of an insertable electrical component except along an axis perpendicular to the bottom surface of the lid.

4. The apparatus of claim 1, wherein the at least one boss comprises a boss contact attached to the at least one boss, wherein the boss contact is configured to provide electrical communication.

5. The apparatus of claim 4, wherein the lid further comprises an exterior contact and an electrical connection, wherein the exterior contact is attached to a top surface of the lid, and wherein the electrical connection electrically couples the exterior contact to the boss contact.

6. The apparatus of claim 1, further comprising a tray configured to receive a medical device associated with the insertable electrical component, wherein the tray includes a discharge device and an electrical connection, wherein the discharge device comprises a plurality of resistors, wherein the discharge device is attached to the tray with the electrical connection positioned to contact a portion of the medical device upon placement of the medical device in the tray, thereby providing discharge of a power source in the medical device upon placement of the medical device in the tray.

7. The apparatus of claim 6, wherein the discharge device is embedded within the tray.

8. The apparatus of claim 6, wherein the discharge device further comprises heat dissipation fins.

9. The apparatus of claim 1, wherein the at least one boss comprises a plurality of boss contacts attached to the at least one boss, wherein the lid further comprises a plurality of exterior contacts and a plurality of electrical connections, wherein the plurality of exterior contacts are attached to a top surface of the lid, and wherein the plurality of electrical connections electrically couple the plurality of exterior contacts to the plurality of boss contacts.

10. The apparatus of claim 1, wherein the lid further comprises an attachment portion configured to provide a snap-on attachment with the container base.

11. The apparatus of claim 1, wherein the lid is adhesively attached to the container base.

12. The apparatus of claim 1, wherein one or both of the container base or the lid are sized and configured to be inserted into a medical device while the lid is attached to the container base.

13. The apparatus of claim 12, wherein the lid further comprises a plurality of exterior contacts and an electrical connection, wherein the exterior contacts are attached to a top surface of the lid, wherein the electrical connection electrically couples the exterior contacts to an interior contact within the container, and wherein the exterior contacts are configured to electrically couple to a plurality of electrical contacts within a medical device.

14. The apparatus of claim 13, wherein at least one of the plurality of exterior contacts is configured for diagnostic testing of an insertable electrical component when an insertable electrical component is electrically coupled to the exterior contact.

15. The apparatus of claim 1, wherein the container base and lid are made of a rigid material.

16. An assembly for providing reclamation of an insertable electrical component from within a medical device, the apparatus comprising:
(a) a medical device, wherein the medical device comprises:
(i) a housing, wherein the housing is sized to contain a power source,
(ii) an active feature selectively activated by a power source contained in the housing; and
(b) a power source contained within the housing of the medical device, the power source comprising:
(i) a sealed package including one or more electrical feed-throughs, wherein the one or more electrical feed-throughs are configured to communicate with the active feature of the medical device,
(ii) at least one electrical component within the sealed package, wherein the at least one electrical component is in communication with the one or more electrical feed-throughs,
wherein the sealed package and the electrical feed-throughs are configured to substantially prevent contamination of the at least one electrical component by bodily fluids infiltrating the housing of the medical device,
wherein the housing is configured to open to provide access to the power source,
wherein the sealed package is configured to open to provide access to the at least one electrical component.

17. The assembly of claim 16, wherein the housing comprises a pair of separable shells, wherein the sealed package comprises a blister pack, wherein the at least one electrical component comprises a battery.
